(19) United States
(12) Patent Application Publication
(10) Pub. No.: US 2017/0245508 A1
(43) Pub. Date: Aug. 31, 2017

(54) FOOD PRODUCT WITH REDUCED SUGAR GRAIN BINDER COMPOSITION

(71) Applicant: Kellogg Company, Battle Creek, MI (US)

(72) Inventors: Guoshen Yang, Battle Creek, MI (US); Jana Turpin, Delton, MI (US); Monjur Hossen, Battle Creek, MI (US); Gregory J. Herbers, Battle Creek, MI (US)

(21) Appl. No.: 15/441,573

(22) Filed: Feb. 24, 2017

Related U.S. Application Data
(60) Provisional application No. 62/299,646, filed on Feb. 25, 2016.

(51) Int. Cl. A21D 13/062; A23L 7/10

(52) U.S. Cl. CPC A21D 13/062; A23L 7/198; A23V 2002/00

(57) ABSTRACT

A method for preparing a food product and a food product thereof including a grain-based binder and being essentially free of added sugar. The method includes preparing a cooked grain flour and then hydrating the cooked grain flour either during or after cooking with a liquid to form a binder composition. The binder composition and one or more food ingredients are combined to form an agglomerate, and the agglomerate is thermally processed to obtain the food product.

### CROSS-REFERENCE TO RELATED APPLICATIONS

This application claims the benefit of and priority to U.S. Application Ser. No. 62/299,646, filed Feb. 25, 2016, which is incorporated herein by reference in its entirety.

### TECHNICAL FIELD

This disclosure relates to binder compositions, and more particularly, to reduced sugar grain binder compositions, food products comprising reduced sugar grain binder compositions, and methods of preparing food products comprising reduced sugar grain binder compositions.

### BACKGROUND

Conventional binder compositions used in snack bars and clusters typically include large amounts of corn syrup or other sugars to provide the required viscosity and cohesion. In many cases, the total amount of sugar may be about 20 to about 35 percent of the total product. However, consumers often desire reduced-sugar substitutes in food products. Common alternative binders include sugar alcohols in place of conventional syrups and sugars. However, food products prepared with large amounts of sugar alcohols may result in digestive discomfort in some consumers.

Accordingly, it is an object of the present disclosure to provide improved binder compositions that offer the functional properties of conventional binder compositions, include nutritive calories, and minimize the associated discomfort from large amounts of sugar alcohols.

### SUMMARY OF THE DISCLOSURE

The present disclosure relates to a food product and methods for preparing a food product. The food product is made from a reduced sugar grain binder composition and one or more dry ingredients. The reduced sugar grain binder composition is prepared from a cooked grain flour or cooked grains and a liquid or it can be prepared by cooking a grain flour or grains with a liquid directly.

In one aspect, the present disclosure provides a method for preparing a food product. The method includes preparing a cooked grain flour or grains and hydrating the cooked grain flour or grains with a liquid to form a binder composition or, alternatively, by cooking the grain flour or grains with liquid to directly form the binder composition. The binder composition and one or more dry ingredients are mixed to form an agglomerate. The agglomerate is thermally processed to obtain the food product. In some embodiments, the step of thermal processing includes forming and baking the agglomerate to obtain the food product.

In another aspect, the present disclosure provides a method for preparing a food product. The method includes preparing a binder composition from a cooked grain flour or grains and a liquid or by cooking the grain flour or grains with a liquid. An agglomerate is then formed from the binder composition and one or more dry ingredients. The agglomerate is thermally processed to obtain the food product. In some embodiments, the step of thermal processing includes forming and baking the agglomerate to obtain the food product.

In yet another aspect, the present disclosure provides a reduced sugar food product prepared by a process comprising the steps of preparing a binder composition from a cooked grain flour or grains and a liquid (or by cooking the grain flour or grains with the liquid), forming an agglomerate from the binder composition and one or more dry ingredients, and thermally processing the agglomerate to obtain the reduced sugar food product. The binder composition is essentially free of an added sugar. In some embodiments, the step of thermal processing includes forming and baking the agglomerate to obtain the reduced sugar food product.

In a further aspect, the present disclosure provides a reduced sugar food product. The reduced sugar food product comprises a binder composition comprising or consisting essentially of a cooked grain flour and a liquid, and one or more dry ingredients. The binder composition is essentially free of an added sugar.

### DESCRIPTION OF THE DRAWINGS

Numerous other objects, features, and advantages of the present disclosure will be apparent based upon the following description of the drawings.

FIG. 1 is a chart showing the rapid visco analyzer (RVA) analysis of a slurry of cooked grain flour and water in accordance with embodiments of the present disclosure.

FIG. 2 is a chart showing the RVA analysis of a slurry of uncooked grain flour and water in accordance with embodiments of the present disclosure.

### DETAILED DESCRIPTION

The present disclosure relates to a reduced or no added sugar grain-based binder composition, food products produced from the same, and methods of making thereof. The binder compositions herein uniquely include grain-based components with little to no added sugar and, in some approaches, include little to no added sugary ingredients, such as sucrose, fructose, dextrose, molasses, corn syrup, high fructose syrup, invert sugar, maple syrup or honey in the binder as commonly used in relatively high amounts in prior binder compositions and associated food bars, bites, clusters, and other cereal-bar type products. In some approaches, the grain-based binder compositions herein include highly elastic cooked grain flours or slurries thereof that uniquely provide binding capabilities without the need for the prior sugary ingredients.

As used herein, the term “binder composition” means a material that produces or promotes cohesion of loosely assembled dry ingredients, and delivers viscosity and functional properties similar to that of conventional corn syrup or sugar binders. The binder compositions comprise one or more cooked grain flours and a liquid. However, the binder compositions of the present disclosure are essentially free of added sugars. The term “essentially free” means less than about 25%, less than about 20%, less than about 15%, less than about 10%, less than about 5%, less than about 3% by weight, less than about 1% by weight, or none within a binder composition. In other approaches, “essentially free” means less than about 5 grams per 40 grams of a total food product, less than about 4 grams per 40 grams of a food product, less than about 3 grams per 40 grams of a food product, less than about 2 grams per 40 grams of a food product, less than about 1 gram per 40 grams of a food product, or no grams per 40 grams of a food product.

As used herein, the term “cooked grain flour slurry” means a slurry of cooked grain flour in water. The term “uncooked grain flour slurry” means a slurry of uncooked grain flour in water.

As used herein, the term “added sugar[s]” includes carbohydrates obtained from such sources as sucrose, dextrose, maltose, dextrin, invert sugar, fructose, levulose, galactose, corn syrup solids, rice, tapioca, honey, molasses, malt extract, brown rice syrup, brown sugar syrup, invert syrup, glucose syrup, cane juice syrup, evaporated cane juice, agave syrup, beet sugar, maple syrup, turbinado, and coconut palm sugar. Added sugar also includes alternative sweeteners including, but not limited to sugar alcohols, such as sorbitol, mannitol, xylitol, isomalt, hydrogenated starch hydrolysates, maltitol, and the like, alone or in any combination.

As used herein a “food product” is a cooked food product that has been subjected to thermal processing, for instance forming and baking. Any uncooked food product may be subjected to thermal processing to obtain a food product. Food products are generally produced by the food industry in such way that they are suitable for consumption without or with minimal further processing. The further processing steps are, for instance, adding a liquid, such as water or milk and/or heating the product. Such processed foods are typically marketed in a dedicated packaging, which either comprises a single or multiple serving sizes of the food product. Furthermore, the packaging of processed foods carries a food label providing information on the ingredients of the product and its nutritional composition as well as on the recommended serving size of the product.

As used herein an “uncooked food product” means an additive, component, or supplement useful in preparing or supplementing a food, or a food intermediate, or a fully prepared composition but in a raw state (requiring a further treatment step prior to consumption, such as baking dough to produce bread). Uncooked food products as provided hereunder generally include any type of food ingredient, food intermediate, or mixtures thereof. The food ingredients can be in any suitable form, including raw or pre-treated. An uncooked food product may be converted into a food product, for instance by cooking. Examples of uncooked food products include uncooked grain flours.

The term “moisture content” as used herein refers to the amount of moisture in a material. The moisture content of a material can be determined by A.O.C.S. (American Oil Chemists Society) Method Ba 2a-38 (1997), which is incorporated herein by reference in its entirety. Moisture content is calculated according to the formula: Moisture content (%)=100×[loss in mass (grams)/mass of sample (grams)].

As used herein “thermal processing” or “thermally processed” means heating by any method. Thermal processing is synonymous with cooking, baking, frying, boiling, grilling, toasting, and the like. In some embodiments, thermal processing includes cooking and drying. In some embodiments, thermal processing includes forming and baking.

The terms “oil” and “fat” are used interchangeably herein to include any edible oil, fat, or shortening. The oil can be any edible oil or shortening, by way of example, any vegetable oil like canola oil, sunflower oil, soybean oil, corn oil, cottonseed oil, peanut oil, safflower oil, palm oil, coconut oil, rice bran oil, olive oil, and/or sesame oil. The oil can be any shortening based on these oils and/or any fractions of these oils.

As used herein, the term “cooked grain flour” means one or more grain flours that are cooked, and optionally dried, to give a cooked grain flour. As defined herein, a “cooked grain flour” is not included in the definition of a “food product.”

As used herein, the term “milk” includes, but is not limited to, cow milk, goat milk, almond milk, soy milk, rice milk, coconut milk, cashew milk, oat milk, hemp milk, and sunflower seed milk.

As used herein, the term “juice” includes, but is not limited to, aloe vera juice, wheatgrass juice, apple juice, cranberry juice, grape juice, grapefruit juice, kiwifruit juice, lemon juice, lime juice, melon juice, orange juice, papaya juice, pineapple juice, pomegranate juice, prune juice, strawberry juice, tomato juice, beet juice, carrot juice, celery juice, cucumber juice, parsley juice, spinach juice, turnip juice, and watercress juice.

As used herein, the term “puree” includes, but is not limited to, apple puree, arracacha puree, carrot puree, cassava puree, pea puree, potato puree, pumpkin puree, rutabaga puree, squash puree, corn puree, tomato puree, cucumber puree, guacamole, muesli, peanut butter, pesto, polenta, red bean paste, and saag.

As used herein, the term “legumes” includes, but is not limited to, beans, chickpeas, cowpeas, fava beans, flat beans, geechee red peas, green beans, kidney beans, lentils, lupin beans, mung beans, peas, peanuts, snap peas, snow peas, soybeans, split peas, tamarind, wattleseed, and winged beans.

Turning to more of the specifics and in one aspect, the present disclosure provides grain-based binder compositions obtained from cooked grain flours or cooked grains, methods for preparing the grain-based binders, food products thereof and methods of preparing such food products including a grain-based binder with little to no-added sugars. In one approach, the method includes preparing a cooked grain flour, cooked grains, or slurry thereof, drying the cooked grain flour or cooked grains, and then hydrating the cooked grain flour or cooked grains with a liquid (and other optional ingredients) to form a grain-based binder composition. In another approach, the method includes cooking a grain flour or raw grains to form a cooked grain flour slurry or a cooked grain slurry that is then directly combined with other optional ingredients to form a grain-based binder composition without an intermediate drying step. In either instance, the grain-based binder composition and one or more dry ingredients are mixed to form an agglomerate. The agglomerate is then formed and/or thermally processed to obtain the food product. In some embodiments, the food product is essentially free of an added sugar.

If drying and hydration are employed, the cooked grain flour or cooked grains and the liquid may be mixed for rehydration using any suitable method to form the binder composition. The binder composition and the one or more dry ingredients may also be mixed using any suitable method to form the agglomerate. In some embodiments, a rotary mixer may be used for mixing.

The cooked grain flour, cooked grains (or the cooked grain flour slurry, cooked grain slurry) is comprised of one or more grain flours or one or more grains. Suitable grain flours or grains include, but are not limited to, barley, oat, wheat, corn, millet, buckwheat, quinoa, rice, sorghum, triticale flour, mixtures thereof, and their waxy varieties. In some embodiments, one or more of the grain flours or grains is a whole grain flour. In particular embodiments, the grain flour or grain is selected from the group consisting of barley, oat, and wheat flour. In some embodiments, the one or more grain flours or grains are one or more whole grain flours. In certain embodiments, the grain flour or grain is wheat flour or whole wheat flour.

In other approaches, the cooked grain flour or cooked grains includes sweet brown rice grains or flour and/or waxy wheat grains or flours. These particular grains or flours are advantageous for a grain-based binder composition in view of their high levels of starch, high levels of amylopectin (relative to amylose), and ability to form a highly extensible material that holds dry materials together upon mixing and forming.

As used herein, “flour” generally refers to farinaceous materials in the form of powder, flake, or granule prepared by grinding raw grains, roots, or rice as the case may be to form the flour as understood by those of ordinary skill. In some approaches, examples of flours can be found, for instance, in U.S. Pat. No. 6,171,631; U.S. Pat. No. 8,470,386; or U.S. Pat. No. 9,504,273, which portions thereof are incorporated herein by reference. In some instances, reference to grain flours also refers to or includes grains as needed for a particular application.

The grain flour or grains is preferably a sweet rice or waxy wheat flour due to the higher starch and higher amylopectin content. In some approaches, the grain flour or grain has at least about 50% starch and, in other approaches, at least about 70 percent starch with a high level of amylopectin relative to amylose. The grain flour or grains may preferably include about 60 to about 80 percent starch. In certain approaches, the grain flour or grains used herein have an amylopectin to amylose ratio with about 90 to 98 percent amylopectin and about 2 to about 10 percent amylose. In other approaches, the ratio may be about 93 to about 95 percent amylopectin and about 5 to about 7 percent amylose.

In some embodiments, the uncooked grain flour or grains may be processed prior to cooking using the methods of this disclosure. In some embodiments, the grains or grain flour is treated with one or more enzyme solutions (e.g., amylases, proteases) prior to cooking. In other embodiments, the grains or grain flour is not treated with an enzyme solution. In some embodiments, the grains or grain flour is compressed (e.g., tempered between rollers) before cooking. In other embodiments, the grains or grain flour is not compressed before cooking. In still other embodiments, the grains or grain flour is pre-soaked or steeped before cooking. In other embodiments, the grains or grain flour is not pre-soaked or steeped before cooking.

In some embodiments, the cooked grain flour or cooked grain flour slurry is prepared by cooking one or more grain flours. Any suitable method of cooking may be used. In some embodiments, the cooked grain flour is prepared by extrusion cooking one or more grain flours. In other embodiments, the cooked grain flour is prepared by hydro thermo-cooking (such as, for example, steam jet cooking) one or more grain flours. In some embodiments, the cooked grain flour is prepared by cooking one or more grain flours and then drying the one or more cooked grain flours. Any suitable method of hydro thermo-cooking and drying may be used. In some embodiments, the cooked grain flour is prepared by steam jet cooking the one or more grain flours and drying the one or more cooked grain flours. In still other embodiments, the cooked grain flour is prepared by steam jet cooking the one or more grain flours and drum drying the one or more cooked grain flours. Suitable methods for drum drying include, but are not limited to, single drum drying, double drum drying, vacuum drum drying, and vacuum rotary drying. In yet another embodiment, the cooked grain flour may be prepared by steam jet cooking the one or more grain flours and spray drying the one or more cooked grain flours. In still further embodiments, the cooked grain flour is in a cooked grain flour slurry and prepared by cooking the grain flour in water or cooking the grain flour and then adding water without a drying step.

In some embodiments the cooked grain flour or cooked grain flour slurry is prepared by cooking, which may be steam cooking, the one or more grain flours at a temperature of about 250° F. to about 350° F., about 260° F. to about 340° F., about 270° F. to about 330° F., about 280° F. to about 320° F., about 290° F. to about 310° F., about 300° F. to about 320° F., or about 290° F. to about 300° F. In some embodiments, the cooking is for a time of about 2 minutes to about 8 minutes, about 2 minutes to about 8 minutes, about 2 minutes to about 7 minutes, about 2 minutes to about 6 minutes, about 2 minutes to about 5 minutes, about 2 minutes to about 4 minutes, about 2 minutes to about 3 minutes, about 3 minutes to about 4 minutes, about 4 minutes to about 5 minutes, about 5 minutes to about 6 minutes, about 6 minutes to about 7 minutes, or about 7 minutes to about 8 minutes.

After cooking, the cooked grain flour may be dried at a temperature of about 150° F. to about 250° F., about 160° F. to about 250° F., about 170° F. to about 250° F., about 180° F. to about 250° F., about 190° F. to about 250° F., about 200° F. to about 250° F., about 200° F. to about 300° F., about 210° F. to about 250° F., about 220° F. to about 250° F., about 230° F. to about 250° F., or about 240° F. to about 250° F. In some embodiments, the drying is for a time of about 2 minutes to about 15 minutes, about 3 minutes to about 15 minutes, about 4 minutes to about 15 minutes, about 5 minutes to about 15 minutes, about 6 minutes to about 15 minutes, about 7 minutes to about 15 minutes, about 8 minutes to about 15 minutes, about 9 minutes to about 15 minutes, about 10 minutes to about 15 minutes, about 11 minutes to about 15 minutes, about 12 minutes to about 15 minutes, about 13 minutes to about 15 minutes, or about 14 minutes to about 15 minutes. As discussed further herein, the drying may be drum drying or may be spray drying. Spray drying may be at about 250° F. to about 350° F. for about 1 to about 3 minutes.

In some embodiments, the cooked grain flour or cooked grain flour slurry is prepared by steam jet cooking the one or more grain flours at a temperature of about 250° F. to about 350° F., about 260° F. to about 340° F., about 270° F. to about 330° F., about 280° F. to about 320° F., about 290° F. to about 310° F., about 300° F. to about 320° F., or about 290° F. to about 300° F. In some embodiments, the steam jet cooking is for a time of about 2 minutes to about 8 minutes, about 2 minutes to about 8 minutes, about 2 minutes to about 7 minutes, about 2 minutes to about 6 minutes, about 2 minutes to about 5 minutes, about 2 minutes to about 4 minutes, about 2 minutes to about 3 minutes, about 3 minutes to about 4 minutes, about 4 minutes to about 5 minutes, about 5 minutes to about 6 minutes, about 6 minutes to about 7 minutes, or about 7 minutes to about 8 minutes. In some embodiments, the steam jet cooking is at a pressure of about 100 psig to about 150 psig, about 110 psig to about 150 psig, about 120 psig to about 150 psig, about 130 psig to about 150 psig, about 140 psig to about 150 psig, or about 130 psig.

In some embodiments, the cooked grain flour is prepared by cooking the one or more grain flours to form a cooked grain slurry and then drum drying or spray drying the cooked grain flour or cooked grain slurry. In some embodiments, drum drying is at a temperature of about 200° F. to about 300° F., about 210° F. to about 300° F., about 220° F. to about 300° F., about 230° F. to about 300° F., about 240° F. to about 300° F., about 250° F. to about 300° F., about 260° F. to about 300° F., about 270° F. to about 300° F., about 280° F. to about 300° F., or about 290° F. to about 300° F. In some embodiments, the drum drying is for a time of about 2 minutes to about 15 minutes, about 3 minutes to about 15 minutes, about 4 minutes to about 15 minutes, about 5 minutes to about 15 minutes, about 6 minutes to about 15 minutes, about 6 minutes to about 10 minutes, about 6 minutes to about 9 minutes, about 6 minutes to about 8 minutes, about 6 minutes to about 7 minutes, about 7 minutes to about 15 minutes, about 8 minutes to about 15 minutes, about 9 minutes to about 15 minutes, about 10 minutes to about 15 minutes, about 11 minutes to about 15 minutes, about 12 minutes to about 15 minutes, about 13 minutes to about 15 minutes, or about 14 minutes to about 15 minutes. In other approaches, the spray drying may be at about 250° F. to about 350° F. for about 1 to about 3 minutes.

In some embodiments, the cooked grain flour is prepared by cooking and drying a grain flour to a moisture content. In some embodiments, the cooked grain flour, after drying, has a moisture content of less than about 12%, 11%, 10%, 9%, 8%, 7%, 6%, 5%, 4%, 3%, or 2% by weight based on the total weight of the cooked grain flour. In other embodiments, the cooked grain flour has a moisture content of about 2% to about 12%, about 2% to about 10%, about 3% to about 10%, about 4% to about 10%, about 4% to about 8%, about 5% to about 10%, about 2% to about 5%, about 2% to about 4%, or about 3% to about 9% by weight based on the total weight of the cooked grain flour.

According to some aspects of the present disclosure, the cooked and dried grain flour is hydrated with a liquid to form the binder composition. Suitable liquids include, but are not limited to, water, milk, puree, and juice. In some embodiments, the liquid is water. In some embodiments, the liquid is juice. In some embodiments, the liquid is milk.

In some embodiments, the cooked grain flour and the liquid are included in the binder composition, with or without the drying step, according to a weight ratio. In some embodiments, the weight ratio of the cooked grain flour to the liquid in the binder composition is about 1:1 to about 1:20, about 1:1 to about 1:15, about 1:1 to about 1:10, or about 1:1 to about 1:5. In other embodiments, the binder composition includes cooked grain flour in an amount of about 5% to about 40%, about 5% to about 25%, about 5% to about 20%, about 5% to about 15%, about 10% to about 40%, about 10% to about 15%, about 10% to about 25%, about 20% to about 30%, or about 5% to about 10% by weight based on the total weight of the binder composition.

In some embodiments, the binder composition has a moisture content of between about 10% to about 90%, about 20% to about 90%, about 30% to about 90%, about 40% to about 90%, about 50% to about 90%, about 60% to about 90%, about 70% to about 90%, about 80% to about 90%, about 60% to about 80%, or about 50% to about 75% by weight based on the total weight of the binder composition. In still other embodiments, the binder composition has a moisture content of about 40%, about 45%, about 50%, about 55%, about 60%, about 65%, about 70%, about 75%, about 80%, about 85%, or about 90% by weight based on the total weight of the binder composition.

The binder compositions described herein can be incorporated in any suitable food product (i.e., product needing a binder) to allow the cohesion of the dry ingredients and facilitate the shaping of the final food product. Alternatively, or in addition, the binder compositions may be used like a glaze, to adhere inlays onto surfaces of formed food products.

The binder compositions of the present disclosure can be added to many varieties of food products, for example, cheese and dairy products, cheese substitute, fresh or dried fruit and/or vegetable pieces, spices, nuts, seeds, grains, soy crisps, rice crisps, wheat or bran flakes, pieces of bread or crackers, pieces of meat, dried meat product, or meat imitations, protein nuggets, cereal, granola, natural and/or artificial flavors, and the like, as well as mixtures thereof. When the binder composition is added to snack and/or meal replacement bars and/or clusters, it is useful in binding the dry ingredients of the bars and/or clusters. Prepared food products incorporating the binder compositions of the present disclosure will not disintegrate upon refrigeration or thawing, so that the binding of foods is maintained.

According to aspects of the present disclosure, an agglomerate is formed from the binder composition and one or more dry ingredients. In some embodiments, the dry ingredients include one or more of grain flakes, rolled oats, extruded cereals, extruded legumes, fruits, nuts, ready-to-eat cereals (RTEC), and mixtures thereof. In other embodiments, the dry ingredients may include one or more inclusions. In other embodiments, the food product includes one or more inclusions. Suitable inclusions include, but are not limited to, potatoes, cheese, bacon, onions, protein puffs, protein isolate, puffed candy rice, cranberries, bananas, apricots, blueberries, almonds, sunflower seeds, coconut, peanuts, pecans, and the like, and mixtures thereof.

In some embodiments, the agglomerate includes about 10-50% by weight of the binder composition and about 50-90% by weight of the one or more dry ingredients, based on the total weight of the agglomerate. In other embodiments, the agglomerate includes about 10%, about 15%, about 20%, about 25%, about 30%, about 35%, about 40%, about 45%, or about 50% by weight of the binder composition based on the total weight of the agglomerate. In some embodiments, the agglomerate includes about 50%, about 55%, about 60%, about 65%, about 70%, about 75%, about 80%, about 85%, or about 90% by weight of the one or more dry ingredients based on the total weight of the agglomerate. In still other embodiments, the agglomerate includes the binder composition in an amount of about 15% to about 50%, about 15% to about 45%, about 20% to about 45%, about 25% to about 45%, about 25% to about 40%, about 30% to about 40%, or about 35% to about 45% by weight based on the total weight of the agglomerate. In certain embodiments, the agglomerate includes the one or more dry ingredients in an amount of about 50% to about 85%, about 50% to about 80%, about 55% to about 90%, about 60% to about 90%, about 50% to about 75%, about 70% to about 80%, about 70% to about 90%, or about 80% to about 90% by weight based on the total weight of the agglomerate.

In some embodiments, the agglomerate has a moisture content of about 20%, about 25%, about 30%, about 35%, about 40%, about 45%, about 50%, about 55%, or about 60% by weight based on the total weight of the agglomerate. In still other embodiments, the agglomerate has a moisture content of about 20% to about 60%, about 25% to about 55%, about 30% to about 50%, about 35% to about 45%, or about 40% to about 50% by weight based on the total weight of the agglomerate.

The agglomerate is thermally processed to obtain the food product of the present disclosure. In some embodiments, thermal processing involves forming and baking the agglomerate to obtain the food product. The food product may be processed into any suitable form, including but not limited to bars, cereals, squares, and snack bites. In particular embodiments, the food product has a moisture content of about 1% to about 10%, about 5% to about 10%, about 1% to about 5%, about 2% to about 8%, or about 2% to about 4% by weight based on the total weight of the food product. In some embodiments, the agglomerate is formed and then dried.

In some embodiments, the agglomerate is baked at a temperature of about 200° F. to about 300° F., about 210° F. to about 300° F., about 220° F. to about 300° F., about 230° F. to about 300° F., about 240 to about 300° F., about 250° F. to about 300° F., about 250° F. to about 290° F., about 250° F. to about 280° F., about 250° F. to about 270° F., or about 250° F. to about 260° F. In some embodiments, the agglomerate is baked for about 5 minutes to about 60 minutes, about 10 minutes to about 60 minutes, about 15 minutes to about 60 minutes, about 5 minutes to about 45 minutes, about 10 minutes to about 45 minutes, about 15 minutes to about 45 minutes, about 5 minutes to about 30 minutes, about 10 minutes to about 30 minutes, about 15 minutes to about 30 minutes, about 20 minutes to about 30 minutes, or about 25 minutes to about 30 minutes.

In some embodiments, the method for preparing a food product comprises steam jet cooking and drum drying or spray drying whole wheat flour (or a whole wheat slurry) to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 4% to about 8% by weight based on the total weight of the cooked grain flour. In some embodiments, the steam jet cooking is at a temperature of about 280° C. to about 310° C. for about 4-6 minutes and the drum drying is at a temperature of about 270° C. to about 300° C. for about 6-7 minutes. In some embodiments, the cooked grain flour is hydrated with water to form a binder composition having a moisture content of about 75% by weight based on the total weight of the binder. In some embodiments, the binder composition is then mixed with one or more dry ingredients to form an agglomerate. In some embodiments, the agglomerate comprises about 10% to about 50% by weight of the binder composition and about 50% to about 90% by weight of the one or more dry ingredients based on the total weight of the agglomerate. In some embodiments, the agglomerate is subsequently formed and baked to give a food product. In some embodiments, the binder composition is essentially free of added sugar.

In some embodiments, the method for preparing a food product comprises steam jet cooking and drum drying whole oat flour to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 4% to about 8% by weight based on the total weight of the cooked grain flour. In some embodiments, the steam jet cooking is at a temperature of about 280° C. to about 310° C. for about 4-6 minutes and the drum drying is at a temperature of about 270° C. to about 300° C. for about 6-7 minutes. In some embodiments, the cooked grain flour and a liquid are combined to form a binder composition. In some embodiments, the binder composition is then mixed with one or more dry ingredients to form an agglomerate. In some embodiments, the agglomerate comprises about 10% to about 50% by weight of the binder composition and about 50% to about 90% by weight of the one or more dry ingredients based on the total weight of the agglomerate. In some embodiments, the agglomerate is subsequently formed and baked to give a food product. In some embodiments, the binder composition is essentially free of added sugar.

In some embodiments, the method for preparing a food product comprises steam jet cooking and drum drying whole barley flour to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 1% to about 5% by weight based on the total weight of the cooked grain flour. In some embodiments, the steam jet cooking is at a temperature of about 280° C. to about 310° C. for about 4-6 minutes and the drum drying is at a temperature of about 270° C. to about 300° C. for about 6-7 minutes. In some embodiments, the cooked grain flour and a liquid are combined to form a binder composition. In some embodiments, the binder composition is then mixed with one or more dry ingredients to form an agglomerate. In some embodiments, the agglomerate comprises about 10% to about 50% by weight of the binder composition and about 50% to about 90% by weight of the one or more dry ingredients based on the total weight of the agglomerate. In some embodiments, the agglomerate is subsequently formed and baked to give a food product. In some embodiments, the binder composition is essentially free of added sugar.

In some embodiments, the method for preparing a food product comprises steam jet cooking and drum drying one or more grain flours to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 4% to about 8% by weight based on the total weight of the cooked grain flour. In some embodiments, the steam jet cooking is at a temperature of about 280° C. to about 310° C. for about 4-6 minutes and the drum drying is at a temperature of about 270° C. to about 300° C. for about 6-7 minutes. In some embodiments, the cooked grain flour and a liquid are combined to form a binder composition. In some embodiments, the binder composition includes cooked grain flour in an amount of about 5% to about 30% by weight of the binder composition. In some embodiments, the binder composition is then mixed with one or more dry ingredients to form an agglomerate. In some embodiments, the agglomerate comprises about 10% to about 50% by weight of the binder composition and about 50% to about 90% by weight of the one or more dry ingredients based on the total weight of the agglomerate. In some embodiments, the agglomerate is subsequently formed and baked to give a food product. In some embodiments, the binder composition is essentially free of added sugar.

In some embodiments, the method for preparing a food product comprises steam jet cooking and drum drying one or more grain flours to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 2% to about 10% by weight based on the total weight of the cooked grain flour. In some embodiments, the steam jet cooking is at a temperature of about 290° C. for about 4-6 minutes and the drum drying is at a temperature of about 270° C. to about 300° C. for about 6-7 minutes. In some embodiments, the cooked grain flour and a liquid are combined to form a binder composition. In some embodiments, the binder composition includes cooked grain flour in an amount of about 5% to about 30% by weight of the binder composition. In some embodiments, the binder composition is then mixed with one or more dry ingredients to form an agglomerate. In some embodiments, the agglomerate comprises about 10% to about 50% by weight of the binder composition and about 50% to about 90% by weight of the one or more dry ingredients based on the total weight of the agglomerate. In some embodiments, the agglomerate is subsequently formed and baked to give a food product. In some embodiments, the binder composition is essentially free of added sugar.

In some embodiments, the method for preparing a food product comprises steam jet cooking and drum drying one or more grain flours to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 2% to about 10% by weight based on the total weight of the cooked grain flour. In some embodiments, the steam jet cooking is at a temperature of about 280° C. to about 310° C. for about 4-6 minutes and the drum drying is at a temperature of about 270° C. for about 6-7 minutes. In some embodiments, the cooked grain flour and a liquid are combined to form a binder composition. In some embodiments, the binder composition includes cooked grain flour in an amount of about 5% to about 30% by weight of the binder composition. In some embodiments, the binder composition is then mixed with one or more dry ingredients to form an agglomerate. In some embodiments, the agglomerate comprises about 10% to about 50% by weight of the binder composition and about 50% to about 90% by weight of the one or more dry ingredients based on the total weight of the agglomerate. In some embodiments, the agglomerate is subsequently formed and baked to give a food product. In some embodiments, the binder composition is essentially free of added sugar.

In some embodiments, the method for preparing a food product comprises steam jet cooking and drum drying one or more grain flours to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 2% to about 10% by weight based on the total weight of the cooked grain flour. In some embodiments, the steam jet cooking is at a temperature of about 280° C. to about 310° C. for about 4-6 minutes and the drum drying is at a temperature of about 270° C. to about 300° C. for about 6-7 minutes. In some embodiments, the cooked grain flour and a liquid are combined to form a binder composition. In some embodiments, the binder composition includes cooked grain flour in an amount of about 10% to about 25% by weight of the binder composition. In some embodiments, the binder composition is then mixed with one or more dry ingredients to form an agglomerate. In some embodiments, the agglomerate comprises about 10% to about 50% by weight of the binder composition and about 50% to about 90% by weight of the one or more dry ingredients based on the total weight of the agglomerate. In some embodiments, the agglomerate is subsequently formed and baked to give a food product. In some embodiments, the binder composition is essentially free of added sugar.

In some embodiments, the method for preparing a food product comprises steam jet cooking and drum drying one or more grain flours to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 2% to about 10% by weight based on the total weight of the cooked grain flour. In some embodiments, the steam jet cooking is at a temperature of about 270° C. to about 310° C. for about 4-6 minutes and the drum drying is at a temperature of about 270° C. to about 300° C. for about 6-7 minutes. In some embodiments, the cooked grain flour is combined with a liquid to form a binder composition having a moisture content of about 80% to about 90% by weight based on the total weight of the binder. In some embodiments, the binder composition is then mixed with one or more dry ingredients to form an agglomerate. In some embodiments, the agglomerate comprises about 10% to about 50% by weight of the binder composition and about 50% to about 90% by weight of the one or more dry ingredients based on the total weight of the agglomerate. In some embodiments, the agglomerate is subsequently formed and baked to give a food product. In some embodiments, the binder composition is essentially free of added sugar.

In some embodiments, the method for preparing a food product comprises steam jet cooking and drum drying one or more grain flours to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 2% to about 10% by weight based on the total weight of the cooked grain flour. In some embodiments, the steam jet cooking is at a temperature of about 280° C. to about 310° C. for about 4-6 minutes and the drum drying is at a temperature of about 270° C. to about 300° C. for about 6-7 minutes. In some embodiments, the cooked grain flour and a liquid are combined to form a binder composition. In some embodiments, the binder composition includes cooked grain flour in an amount of about 10% to about 25% by weight of the binder composition. In some embodiments, the binder composition is then mixed with one or more dry ingredients to form an agglomerate. In some embodiments, the agglomerate comprises about 30% by weight of the binder composition and about 70% by weight of the one or more dry ingredients based on the total weight of the agglomerate. In some embodiments, the agglomerate is subsequently formed and baked to give a food product. In some embodiments, the binder composition is essentially free of added sugar.

In some embodiments, the method for preparing a food product comprises steam jet cooking and drum drying one or more grain flours to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 2% to about 10% by weight based on the total weight of the cooked grain flour. In some embodiments, the steam jet cooking is at a temperature of about 280° C. to about 310° C. for about 4-6 minutes and the drum drying is at a temperature of about 270° C. to about 300° C. for about 6-7 minutes. In some embodiments, the cooked grain flour and a liquid are combined to form a binder composition. In some embodiments, the binder composition includes cooked grain flour in an amount of about 10% to about 25% by weight of the binder composition. In some embodiments, the binder composition is then mixed with one or more dry ingredients to form an agglomerate. In some embodiments, the agglomerate comprises about 35% by weight of the binder composition and about 65% by weight of the one or more dry ingredients based on the total weight of the agglomerate. In some embodiments, the agglomerate is subsequently formed and baked to give a food product. In some embodiments, the binder composition is essentially free of added sugar.

In some embodiments, the method for preparing a food product comprises steam jet cooking and drum drying one or more grain flours to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 2% to about 10% by weight based on the total weight of the cooked grain flour. In some embodiments, the steam jet cooking is at a temperature of about 280° C. to about 310° C. for about 4-6 minutes and the drum drying is at a temperature of about 270° C. to about 300° C. for about 6-7 minutes. In some embodiments, the cooked grain flour and a liquid are combined to form a binder composition. In some embodiments, the binder composition includes cooked grain flour in an amount of about 10% to about 25% by weight of the binder composition. In some embodiments, the binder composition is then mixed with one or more dry ingredients to form an agglomerate. In some embodiments, the agglomerate comprises about 10% to about 50% by weight of the binder composition and about 50% to about 90% by weight of the one or more dry ingredients based on the total weight of the agglomerate. In some embodiments, the agglomerate has a moisture content of about 20% to about 60% by weight based on the total weight of the agglomerate. In some embodiments, the agglomerate is subsequently formed and baked to give a food product. In some embodiments, the binder composition is essentially free of added sugar.

In some embodiments, the method for preparing a food product comprises steam jet cooking and drum drying one or more grain flours to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 2% to about 10% by weight based on the total weight of the cooked grain flour. In some embodiments, the steam jet cooking is at a temperature of about 280° C. to about 310° C. for about 4-6 minutes and the drum drying is at a temperature of about 270° C. to about 300° C. for about 6-7 minutes. In some embodiments, the cooked grain flour and a liquid are combined to form a binder composition. In some embodiments, the binder composition includes cooked grain flour in an amount of about 10% to about 25% by weight of the binder composition. In some embodiments, the binder composition is then mixed with one or more dry ingredients to form an agglomerate. In some embodiments, the agglomerate comprises about 10% to about 50% by weight of the binder composition and about 50% to about 90% by weight of the one or more dry ingredients based on the total weight of the agglomerate. In some embodiments, the agglomerate is subsequently formed and baked to give a food product with a moisture content of about 1% to about 10% by weight based on the total weight of the food product. In some embodiments, the binder composition is essentially free of added sugar.

In some embodiments, the method for preparing a food product comprises steam jet cooking and drum drying one or more grain flours to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 2% to about 10% by weight based on the total weight of the cooked grain flour. In some embodiments, the steam jet cooking is at a temperature of about 280° C. to about 310° C. for about 4-6 minutes and the drum drying is at a temperature of about 270° C. to about 300° C. for about 6-7 minutes. In some embodiments, the cooked grain flour and a liquid are combined to form a binder composition. In some embodiments, the binder composition includes cooked grain flour in an amount of about 10% to about 25% by weight of the binder composition. In some embodiments, the binder composition is then mixed with one or more dry ingredients to form an agglomerate. In some embodiments, the agglomerate comprises about 25% by weight of the binder composition and about 75% by weight of the one or more dry ingredients based on the total weight of the agglomerate. In some embodiments, the agglomerate is subsequently formed and baked to give a food product. In some embodiments, the binder composition is essentially free of added sugar.

In some embodiments, the method for preparing a food product comprises steam jet cooking and drum drying one or more grain flours to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 2% to about 10% by weight based on the total weight of the cooked grain flour. In some embodiments, the steam jet cooking is at a temperature of about 280° C. to about 310° C. for about 4-6 minutes and the drum drying is at a temperature of about 270° C. to about 300° C. for about 6-7 minutes. In some embodiments, the cooked grain flour and a liquid are combined to form a binder composition. In some embodiments, the binder composition includes cooked grain flour in an amount of about 10% to about 25% by weight of the binder composition. In some embodiments, the binder composition is then mixed with one or more dry ingredients to form an agglomerate. In some embodiments, the agglomerate comprises about 38% by weight of the binder composition and about 62% by weight of the one or more dry ingredients based on the total weight of the agglomerate. In some embodiments, the agglomerate is subsequently formed and baked to give a food product. In some embodiments, the binder composition is essentially free of added sugar.

In some embodiments, the method for preparing a food product comprises steam jet cooking and drum drying one or more grain flours to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 2% to about 10% by weight based on the total weight of the cooked grain flour. In some embodiments, the steam jet cooking is at a temperature of about 280° C. to about 310° C. for about 4-6 minutes and the drum drying is at a temperature of about 270° C. to about 300° C. for about 6-7 minutes.

In some embodiments, a cooked grain flour and a liquid are combined to provide a sample slurry. In some embodiments, the sample slurry includes cooked grain flour in an amount of about 10% to about 25%, about 10% to about 20%, or about 10% to about 15% by weight of the sample slurry. In some embodiments, the liquid of the sample slurry is water. In some embodiments, the sample slurry includes water in an amount of about 90% to about 75%, about 90% to about 80%, or about 90% to about 85% by weight of the sample slurry. In some embodiments, the sample slurry includes cooked grain flour in an amount of about 12.3% and water in an amount of about 87.7% by weight of the sample slurry. In some embodiments, the sample slurry does not demonstrate pasting properties as measured using RVA with an initial temperature of about 50° C. (122° F.) and a maximum temperature of about 95° C. (203° F.).

In some embodiments, the method for preparing a food product comprises steam jet cooking and drum drying one or more grain flours to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 4% to about 8% by weight based on the total weight of the cooked grain flour. In some embodiments, the steam jet cooking is at a temperature of about 290° C. for about 4-6 minutes and the drum drying is at a temperature of about 270° C. for about 6-7 minutes. In some embodiments, the cooked grain flour and a liquid are combined to form a binder composition. In some embodiments, the binder composition includes cooked grain flour in an amount of about 10% to about 25% by weight of the binder composition. In some embodiments, the binder composition is then mixed with one or more dry ingredients to form an agglomerate. In some embodiments, the agglomerate comprises about 10% to about 50% by weight of the binder composition and about 50% to about 90% by weight of the one or more dry ingredients based on the total weight of the agglomerate. In some embodiments, the agglomerate is subsequently formed and baked to give a food product. In some embodiments, the binder composition is essentially free of added sugar.

In some embodiments, the method for preparing a food product comprises steam jet cooking and drum drying one or more grain flours to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 4% to about 8% by weight based on the total weight of the cooked grain flour. In some embodiments, the steam jet cooking is at a temperature of about 280° C. to about 310° C. for about 4-6 minutes and at a pressure of about 100 psig to about 150 psig. In some embodiments, the drum drying is at a temperature of about 270° C. to about 300° C. for about 6-7 minutes. In some embodiments, the cooked grain flour and a liquid are combined to form a binder composition. In some embodiments, the binder composition includes cooked grain flour in an amount of about 10% to about 25% by weight of the binder composition. In some embodiments, the binder composition is then mixed with one or more dry ingredients to form an agglomerate. In some embodiments, the agglomerate comprises about 10% to about 50% by weight of the binder composition and about 50% to about 90% by weight of the one or more dry ingredients based on the total weight of the agglomerate. In some embodiments, the agglomerate is subsequently formed and baked to give a food product. In some embodiments, the binder composition is essentially free of added sugar.

In some embodiments, the method for preparing a food product comprises steam jet cooking and drum drying one or more grain flours to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 4% to about 8% by weight based on the total weight of the cooked grain flour. In some embodiments, the steam jet cooking is at a temperature of about 280° C. to about 310° C. for about 4-6 minutes and at a pressure of about 130 psig. In some embodiments, the drum drying is at a temperature of about 270° C. to about 300° C. for about 6-7 minutes. In some embodiments, the cooked grain flour and a liquid are combined to form a binder composition. In some embodiments, the binder composition includes cooked grain flour in an amount of about 10% to about 25% by weight of the binder composition. In some embodiments, the binder composition is then mixed with one or more dry ingredients to form an agglomerate. In some embodiments, the agglomerate comprises about 10% to about 50% by weight of the binder composition and about 50% to about 90% by weight of the one or more dry ingredients based on the total weight of the agglomerate. In some embodiments, the agglomerate is subsequently formed and baked to give a food product. In some embodiments, the binder composition is essentially free of added sugar.

In some embodiments, the method for preparing a food product comprises steam jet cooking and drum drying one or more grain flours to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 4% to about 8% by weight based on the total weight of the cooked grain flour. In some embodiments, the steam jet cooking is at a temperature of about 290° C. for about 4-6 minutes and at a pressure of about 130 psig. In some embodiments, the drum drying is at a temperature of about 270° C. for about 6-7 minutes. In some embodiments, the cooked grain flour and a liquid are combined to form a binder composition. In some embodiments, the binder composition includes cooked grain flour in an amount of about 10% to about 25% by weight of the binder composition. In some embodiments, the binder composition is then mixed with one or more dry ingredients to form an agglomerate. In some embodiments, the agglomerate comprises about 10% to about 50% by weight of the binder composition and about 50% to about 90% by weight of the one or more dry ingredients based on the total weight of the agglomerate. In some embodiments, the agglomerate is subsequently formed and baked to give a food product. In some embodiments, the binder composition is essentially free of added sugar.

In some embodiments, the method for preparing a food product comprises steam jet cooking and drum drying one or more grain flours to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 4% to about 8% by weight based on the total weight of the cooked grain flour. In some embodiments, the steam jet cooking is at a temperature of about 290° C. for about 4-6 minutes and at a pressure of about 130 psig. In some embodiments, the drum drying is at a temperature of about 270° C. for about 6-7 minutes. In some embodiments, the cooked grain flour and milk are combined to form a binder composition. In some embodiments, the binder composition includes cooked grain flour in an amount of about 10% to about 25% by weight of the binder composition. In some embodiments, the binder composition is then mixed with one or more dry ingredients to form an agglomerate. In some embodiments, the agglomerate comprises about 10% to about 50% by weight of the binder composition and about 50% to about 90% by weight of the one or more dry ingredients based on the total weight of the agglomerate. In some embodiments, the agglomerate is subsequently formed and baked to give a food product. In some embodiments, the binder composition is essentially free of added sugar.

In some embodiments, the method for preparing a food product comprises steam jet cooking and drum drying one or more grain flours to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 4% to about 8% by weight based on the total weight of the cooked grain flour. In some embodiments, the steam jet cooking is at a temperature of about 290° C. for about 4-6 minutes and at a pressure of about 130 psig. In some embodiments, the drum drying is at a temperature of about 270° C. for about 6-7 minutes. In some embodiments, the cooked grain flour and a juice are combined to form a binder composition. In some embodiments, the binder composition includes cooked grain flour in an amount of about 10% to about 25% by weight of the binder composition. In some embodiments, the binder composition is then mixed with one or more dry ingredients to form an agglomerate. In some embodiments, the agglomerate comprises about 10% to about 50% by weight of the binder composition and about 50% to about 90% by weight of the one or more dry ingredients based on the total weight of the agglomerate. In some embodiments, the agglomerate is subsequently formed and baked to give a food product. In some embodiments, the binder composition is essentially free of added sugar.

In some embodiments, the method for preparing a food product comprises steam jet cooking and drum drying one or more grain flours to give a cooked grain flour. In some embodiments, the steam jet cooking is at a first temperature for a first amount of time and the drum drying is at a second temperature for a second amount of time, wherein the temperatures and times each are selected to give a cooked grain flour with a moisture content of about 4% to about 8% by weight based on the total weight of the cooked grain flour. In some embodiments, the steam jet cooking is at a temperature of about 290° C. for about 4-6 minutes and at a pressure of about 130 psig. In some embodiments, the drum drying is at a temperature of about 270° C. for about 6-7 minutes. In some embodiments, the cooked grain flour and a puree are combined to form a binder composition. In some embodiments, the binder composition includes cooked grain flour in an amount of about 10% to about 25% by weight of the binder composition. In some embodiments, the binder composition is then mixed with one or more dry ingredients to form an agglomerate. In some embodiments, the agglomerate comprises about 10% to about 50% by weight of the binder composition and about 50% to about 90% by weight of the one or more dry ingredients based on the total weight of the agglomerate. In some embodiments, the agglomerate is subsequently formed and baked to give a food product. In some embodiments, the binder composition is essentially free of added sugar.

In some embodiments, the binder composition has a viscosity of about 20,000 cps to about 200,000 cps, about 40,000 cps to about 200,000 cps, or about 80,000 cps to about 200,000 cps at a shear rate of 1 s⁻¹ and measured with a Brookfield Digital Viscometer using an SC4-27 spindle (Brookfield Engineering Laboratories, Inc.). In other embodiments, the binder composition has a viscosity of about 10,000 cps to about 100,000 cps, about 30,000 cps to about 100,000 cps, or about 70,000 cps to about 90,000 cps at a shear rate of 1 s⁻¹ and measured with an AR2000ex Rheometer using a Starch Pasting Cell (TA Instruments). For both methods, the viscosity is as measured at ambient temperature (about 70 to about 75° F.).

In combination with the low viscosities noted above, the binder compositions may also include a high extensibility such as greater than about 20 mm, greater than about 30 mm, and greater than about 50 mm. In other approaches, the binder compositions may include an extensibility of about 20 to about 60 mm, in other approaches, about 30 to about 60 mm, and in yet other approaches, about 45 to about 60 mm of extensibility or stringiness. As used herein, extensibility or stringiness is measured using a TA-TX2i texture analyzer equipped with a 22 mm acrylic cylinder for a pull test. The stringiness of a slurry prepared with the processed grain flours herein (50 g at 15% solids content in a liquid within a 100 mL cup) was determined through a pulling test with the acrylic cylinder carried out at a speed of about 40 mm/s before the string breaks. In some approaches, the binder composition includes a cooked sweet brown rice flour or a cooked waxy wheat flour with an extensibility of about 45 to about 60 mm.

In other approaches, the cooked and dried grain flour may have a weight average molecular weight of about 40×10⁶ g/mol or greater, and in some approaches, about 100×10⁶ g/mol or greater. In other approaches, the weight average molecular weight of the cooked and dried grain flour may be about 40 to about 100×10⁶ g/mol. In some approaches, the weight average molecular weight may be about 30 to about 50×10⁶ g/mol for a cooked and spray dried grain flour and may be about 80 to about 110×10⁶ g/mol for a cooked and drum dried grain flour.

In some embodiments, the binder composition includes an ingredient such as a fat, an oil, a salt, or a flavoring. In some embodiments, the binder composition may include one or more fats, one or more oils, one or more salts, and/or one or more flavorings. In some embodiments, the binder composition includes oil in an amount of about 1% to about 10%, about 2% to about 10%, about 2% to about 8%, about 2% to about 5%, or about 2% to about 4% based on the total weight of the binder composition. In certain embodiments, the binder composition includes salt in an amount of about 0.1% to about 2%, about 0.2% to about 2%, about 0.5% to about 2%, about 0.1% to about 1%, or about 0.5% to about 1% by weight based on the total weight of the binder composition. In some embodiments, the binder composition includes flavoring in an amount of about 0.1% to about 1%, about 0.25% to about 1%, about 0.5% to about 1%, or about 0.1% to about 0.5% by weight based on the total weight of the binder composition. In some embodiments, the binder composition includes an antioxidant in an amount of about 0.01% to about 0.2%, about 0.05% to about 0.2%, about 0.1% to about 0.2%, about 0.01% to about 0.1%, about 0.02% to about 0.1%, or about 0.05% to about 0.1% by weight based on the total weight of the binder composition.

According to another aspect of the present disclosure, another method of preparing a food product is provided. The method includes preparing a binder composition from a cooked grain flour and a liquid. An agglomerate is then formed from the binder composition and one or more dry ingredients. The agglomerate is subsequently thermally processed to obtain the food product. Although bars, mixes, and/or clusters are some identified applications of the binder composition of the present disclosure, any other type food product normally incorporating a binder composition is contemplated herein. Of course, the concentration of the binder composition can be adapted depending on its use or the product in which it is incorporated.

Aspects of the present disclosure also include a reduced sugar food product that is prepared by a process that includes the steps of: (a) preparing a binder composition from a cooked grain flour and a liquid; (b) forming an agglomerate from the binder composition and one or more dry ingredients; and (c) thermally processing the agglomerate to obtain the reduced sugar food product. The reduced sugar food product does not include an added sugar, as defined herein.

The scope of this disclosure also includes a reduced sugar food product that comprises a binder composition comprising or consisting essentially of a cooked grain flour and a liquid, along with one or more dry ingredients. The binder composition is essentially free of an added sugar. The properties of the binder composition, the cooked grain flour, the liquid, the dry ingredients, and the food product are as described hereinabove.

The agglomerates and food products of the present disclosure may also include a variety of additives or inclusions. Additives or inclusions can include combinations of, by way of nonlimiting examples: fruit pieces, preferably dried; fruit juice concentrates; fruit purees; vegetable pieces; nuts or nut meats; seeds; legumes, preferably dried; raisins; carob or chocolate chips; yogurt chips; compound coating chips; white chocolate; coconut flakes; broken ready to eat cereal pieces (as nonlimiting examples, rice bubbles or DX crisps); toffee; pretzel pieces; cheese pieces, preferably dried or crumbled; meat pieces, preferably dried (e.g., bacon bits), and other food pieces for flavor and novelty. The additives can also include additional sources of soluble fiber besides those found in the grain flours; these can include sources such as inulin, fructo-oligosaccharides, galacto-oligosaccharides, corn fiber, and wheat fiber. The additives can include additional protein such as protein flakes, protein nuggets, protein concentrates, and protein isolates from any sources including soy, whey, milk, egg, pea, and legume. The additives can include hydrocolloids such as xanthan gum, guar gum, locust bean gum, acacia gum, alginates, and carrageenans. The additives can include cellulosics such as microcrystalline cellulose, methylcellulose, ethyl cellulose, carboxymethylcellulose, and hydroxyl propyl methylcellulose.

Carbohydrate used for the current disclosure may constitute about 1% to about 90%, about 1% to about 80%, about 1% to about 75%, about 1% to about 50%, about 1% to about 25%, about 5% to about 20%, or about 8% to about 18% by weight of the cooked food product or food component. Suitable carbohydrates include, but are not limited to, wheat flour, flour, dextrin, maltodextrin, carboxymethylcellulose (CMC), methylcellulose, hydroxypropylmethylcellulose (HPMC), guar gum, locust bean gum, xanthan gum, carrageenan, algins, levan, elsinan, pullulan, pectins, chitosan, and gum arabic; native starches such as corn starch, waxy maize starch, high-amylose corn starch, potato, tapioca, rice and wheat starch, modified starches such as those that have been acid modified, bleached, oxidized, esterified, etherified, and combinations thereof.

An optional emulsifier can be included and may be any used in typical thermal processing methods and includes, by way of example only, lecithin, diacetyl tartaric ester of monoglyceride (DATEM), mono- and di-glycerides, and sodium stearoyl lactylate. In some embodiments, the emulsifier is present in an amount of 0 to about 0.5%, about 0.05% to about 0.5%, or about 0.1% to about 0.4% by weight based on the total weight of the cooked food product. The high intensity sweetener, including but not limited to stevia, Monk Fruit Extract, and sucralose may be added to enhance flavor. In some embodiments, flavor modifies such as SweetGEM or TasteGEM may also be used to enhance flavor. In some embodiments, the high intensity sweeteners may be included in an amount of about 0.01 to about 0.1% by weight based on the total weight of the cooked food product.

An optional starch may be used for the current disclosure, and is obtained from a source selected from the group of native leguminous starch, native cereal starch, native root starch, native tuber starch, native fruit starch, native algae starch, modified leguminous starch, modified cereal starch, modified root starch, modified tuber starch, modified fruit starch, modified algae starch, waxy type starches, or mixtures thereof. Typical sources for the starch are cereals, tubers, roots, legumes, fruit, algae, and hybrid starches. Suitable sources include but are not limited to wheat, corn, pea, potato, sweet potato, sorghum, banana, barley, rice, sago, amaranth, tapioca, arrowroot, and cane.

Colorants or coloring agents used for the current disclosure can be used in any suitable amount to produce a desired color. Further, the cooked food products of the present disclosure may have multi-colored patterns and/or other related designs or shapes to produce color contrasts. Coloring agents can include, for example, natural food colors and dyes suitable for food, drug, and cosmetic applications. The colorants are typically known as FD&C dyes and lakes such as FD&C Blue No. 1, FD&C Blue No. 2, FD&C Green No. 3, FD&C Yellow No. 5, FD&C Yellow No. 6, FD&C Red No. 3, FD&C Red No. 33, FD&C Red No. 40, and combinations thereof. The coloring agents may constitute about 0.01% to about 2% by weight of the cooked food product.

Preservatives used for the current disclosure may be employed to ensure the safety and quality of the cooked food product. Suitable preservatives include, but are not limited to, sorbic acid, sodium benzoate, potassium sorbate, methyl p-hydroxybenzoate, sodium propionate, and propyl p-hydroxybenzoate alone or in any combination. In addition, suitable antioxidants, for instance BHT, rosemary extract, mixed tocopherols, and green tea extract, can also be utilized. Preservatives or the antioxidants may be present in an amount of about 0.01% to about 1% by weight of the cooked food product.

Nutritional or supplemental additives used for the current disclosure include ingredients such as vitamins, antioxidants, minerals, trace elements, fibers, and mixtures thereof. The vitamins may include vitamin A, B1 (thiamin), B2 (riboflavin), B6, B12, C, D, E and/or derivative thereof, niacin, folic acid, biotin, and pantothenic acid in a nutritionally acceptable form and amount. Examples of mineral and trace elements include calcium, iron, phosphorous, iodine, magnesium, manganese, zinc, copper, sodium, choline, potassium, selenium, and chromium in a nutritionally acceptable form and amount. Suitable antioxidants include alpha-tocopherol, citric acid, butylated hydroxytoluene, butylated hydroxyanisole, ascorbic acid, fumaric acid, malic acid, sodium ascorbate, and ascorbic acid palmitate in a nutritionally acceptable form and amount.

### EXAMPLES

The following Examples are illustrative of the present disclosure but are not meant to be limiting thereof.

### Example 1

In accordance with some embodiments, a binder composition of the present disclosure may be comprised of the following ingredients:

| | Broadest range | Narrower range |
|---|---|---|
| | of percent | of percent |
| | by weight | by weight |
| | based on | based on |
| Component | total weight | total weight |
| Cooked grain flour | 5-30 | 10-15 |
| Water | 60-90 | 75-90 |
| Fat or Oil | 0-10 | 2-8 |
| Salt | 0-2 | 0-1 |
| Flavorings | 0-1 | 0-0.5 |

The whole grain flour can be first cooked and dried by using a two-step process of steam jet cooking and drum drying. The whole grain flour can be steam jet cooked at about 290° C. for about 4-6 minutes and then drum dried at about 270° C. for about 6-7 minutes to give the cooked grain flour. The cooked grain flour can be then hydrated with water. The hydrated cooked grain flour can be optionally mixed with fat or oil, salt, and/or flavorings to give the binder composition.

### Example 2

In accordance with some embodiments, the binder composition of the present disclosure may be comprised of the following ingredients:

| | Broadest range | Narrower range |
|---|---|---|
| | of percent | of percent |
| | by weight | by weight |
| | based on | based on |
| Component | total weight | total weight |
| Cooked grain flour | 5-30 | 10-15 |
| 2% Milk | 60-90 | 75-90 |
| Fat or Oil | 0-10 | 2-8 |
| Salt | 0-2 | 0-1 |
| Flavorings | 0-1 | 0-0.5 |

The whole grain flour can be first cooked and dried by using a two-step process of steam jet cooking and drum drying. The whole grain flour can be steam jet cooked at about 290° C. for about 4-6 minutes and then drum dried at about 270° C. for about 6-7 minutes to give the cooked grain flour. The cooked grain flour can then be hydrated with 2% milk. The hydrated cooked grain flour may be subsequently mixed with fat or oil, salt, and/or flavorings to give the binder composition.

### Example 3

In accordance with some embodiments, the binder composition of the present disclosure may be comprised of the following ingredients:

| | Broadest range | Narrower range |
|---|---|---|
| | of percent | of percent |
| | by weight | by weight |
| | based on | based on |
| Component | total weight | total weight |
| Cooked grain flour | 5-30 | 10-15 |
| Grape juice | 60-90 | 75-90 |
| Fat or Oil | 0-10 | 2-8 |
| Salt | 0-2 | 0-1 |
| Flavorings | 0-1 | 0-0.5 |
| Antioxidant | 0-0.2 | .02-0.1 |

The whole grain flour may be first cooked and dried by using a two-step process of steam jet cooking and drum drying. The whole grain flour can be steam jet cooked at about 290° C. for about 4-6 minutes and then drum dried at about 270° C. for about 6-7 minutes to give the cooked grain flour. The cooked grain flour can then be hydrated with grape juice (100%). The hydrated cooked grain flour may then subsequently be mixed with fat or oil, salt, flavorings, and/or antioxidants to give the binder composition.

### Example 4

In accordance with some embodiments, a savory bar food product may comprise about 30% by weight of a binder composition prepared as described in Example 1. The dry ingredients of the savory bar food product of the present disclosure may comprise the following ingredients:

| | Broadest range | Narrower range |
|---|---|---|
| | of percent | of percent |
| | by weight | by weight |
| | based on | based on |
| Component | total weight | total weight |
| Baked potato crisp | 50-80 | 60-70 |
| Freeze dried cheese | 5-20 | 5-10 |
| Bacon crumb | 5-30 | 10-20 |
| Freeze dried green onion | 1-5 | 1-3 |
| Seasoning | 1-10 | 1-6 |
| Salt | 0-2 | 0-1 |

The binder composition and ingredients may be combined and mixed to form agglomerates. After mixing, the resulting product can be formed into bars using known slabbing and forming processes. Formed bars can be dried at about 250° F. for about 20-30 minutes to give savory bar food products.

### Example 5

In accordance with some embodiments, a fruit and nut bar food product may comprise about 30% by weight of a binder composition prepared as described in Example 2. The dry ingredients of the fruit and nut bar food product of the present disclosure may comprise the following ingredients:

| | Broadest range | Narrower range |
|---|---|---|
| | of percent | of percent |
| | by weight | by weight |
| | based on | based on |
| Component | total weight | total weight |
| Puffed rice bubbles | 1-10 | 5-10 |
| Protein puff | 1-10 | 5-10 |
| Puffed candy rice | 1-10 | 5-10 |
| #3 Rolled oat | 1-10 | 5-10 |
| Diced cranberry bite | 1-10 | 5-10 |
| Diced banana | 1-15 | 10-15 |
| Diced apricot | 1-15 | 5-15 |
| Diced blueberry | 1-15 | 5-15 |

The binder composition and ingredients may be combined and mixed to form agglomerates. After mixing, the resulting product can be formed into bars using known slabbing and forming processes. The formed bars can be dried at about 250° F. for about 20-30 minutes to give fruit and nut bar food products.

### Example 6

In accordance with some embodiments, a granola cereal food product may comprise about 30% by weight of a binder composition prepared as described in Example 3. The dry ingredients of the granola cereal food product of the present disclosure may comprise the following ingredients:

| | Broadest range | Narrower range |
|---|---|---|
| | of percent | of percent |
| | by weight | by weight |
| | based on | based on |
| Component | total weight | total weight |
| Rolled oat | 10-40 | 20-30 |
| Quick oat | 10-40 | 20-30 |
| Toasted coconut | 0-20 | 10-15 |
| Dried apricot | 0-40 | 20-30 |
| Pecan pieces | 0-30 | 10-20 |
| Whey protein isolate | 0-10 | 2-8 |
| Cinnamon | 0-2 | 0-1 |

The binder composition and ingredients may be combined and mixed to form agglomerates. After mixing, the resulting product may be formed into cereal pieces using known rolling and forming processes. The cereal pieces can be dried at about 250° F. for about 20-30 minutes to give a granola cereal food product.

### Example 7

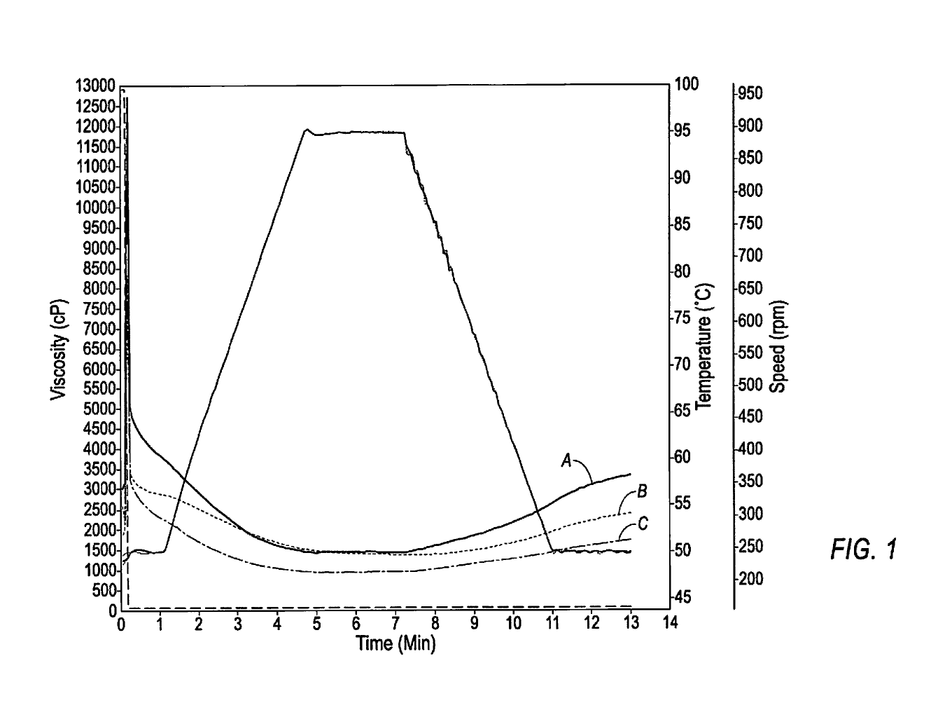

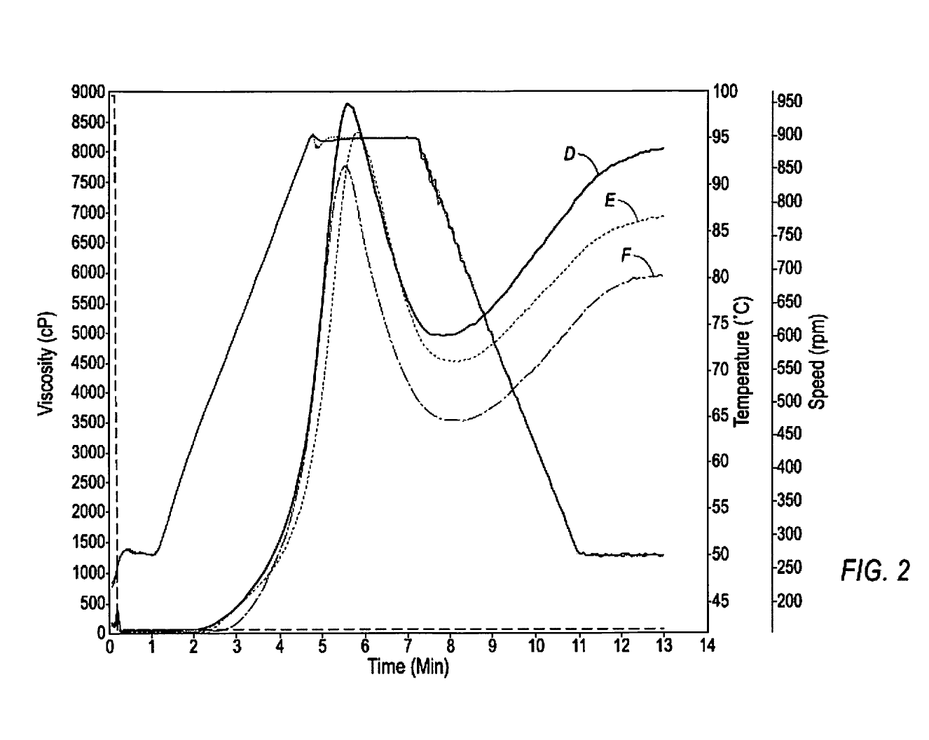

The thermomechanical properties, including the viscosity profile, of sample slurries (cooked grain flour and water) were characterized using a rapid visco analyzer (RVA). The sample slurries were prepared using a mixture of 12.3% cooked grain flour to 87.7% water. The data obtained for the sample slurries A, B, and C using RVA is shown in FIG. 1 and summarized below in Table 1. The peak times measured for the sample slurries A, B, and C were less than the measured peak times for the comparable slurries D, E, and F of uncooked grain flour and water when measured with an RVA with an initial temperature of about 50° C. (122° F.) and a maximum temperature of about 95° C. (203° F.). The comparable slurries D, E, and F were prepared using one or more grain flours that were the same as the one or more grain flours in the sample slurries, with the exception that the one or more grain flours of the comparable slurries were not cooked or dried according to the aspects of the present disclosure. The liquid for the comparable slurries D, E, and F was the same as the liquid used to prepare the sample slurries A, B, and C (i.e., water). The comparable slurries were prepared using a mixture of 12.3% uncooked grain flour to 87.7% water. The data for the comparable slurries D, E, and F using RVA is shown in FIG. 2 and summarized below in Table 2.

TABLE 1

| | | | | Final | | Peak | |
|---|---|---|---|---|---|---|---|
| Sample | Peak 1 | Trough 1 | Breakdown | Viscosity | Setback | Time | Pasting |
| Slurry | (cP) | (cP) | (cP) | (cP) | (cP) | (min.) | Temp. (° C.) |
| A | 3815 | 1434 | 2381 | 3335 | 1901 | 1.05 | N/A |
| B | 2283 | 948 | 1335 | 1730 | 782 | 1.05 | N/A |
| C | 2871 | 1366 | 1505 | 2380 | 1014 | 1.05 | N/A |

A: jet cooked seven whole grain flour blend (30% oat, 15% wheat, 15% rye, 10% rice, 10% triticale, 10% barley, 5% buckwheat).
B: jet cooked whole oat flour and brown rice flour blend (70% oat, 30% brown rice).
C: jet cooked whole oat flour (100% oat).

TABLE 2

| | | | | Final | | Peak | Pasting |
|---|---|---|---|---|---|---|---|
| Comparable | Peak 1 | Trough 1 | Breakdown | Viscosity | Setback | Time | Temp. |
| Slurry | (cP) | (cP) | (cP) | (cP) | (cP) | (min.) | (° C.) |
| D | 8824 | 4950 | 3874 | 8051 | 3101 | 5.58 | 66.3 |
| E | 7779 | 3531 | 4248 | 5951 | 2420 | 5.52 | 71.9 |
| F | 8335 | 4520 | 3815 | 6929 | 2409 | 5.85 | 67 |

D: uncooked seven whole grain flour blend (30% oat, 15% wheat, 15% rye, 10% rice, 10% triticale, 10% barley, 5% buckwheat).
B: uncooked whole oat flour and brown rice flour blend (70% oat, 30% brown rice).
C: uncooked whole oat flour (100% oat).

In some embodiments, the sample slurries A, B, and C did not demonstrate pasting properties as measured using RVA with an initial temperature of about 50° C. (122° F.) and a maximum temperature of about 95° C. (203° F.). As used herein, “not demonstrating pasting properties” means that when sample slurries were heated in the RVA, the viscosity of the sample slurries did not increase in a manner commensurate with that expected for pasting. Data supporting these observations is found in FIG. 1 and Table 1.

In some embodiments, the hot paste viscosity of the sample slurries A, B, and C at about 95° C. (203° F.) was less than a hot paste viscosity of the comparable slurries D, E, and F of uncooked grain flour and liquid at about 95° C. (203° F.), as measured by RVA with an initial temperature of about 50° C. (122° F.) and a maximum temperature of about 95° C. (203° F.). The comparable slurries D, E, and F were prepared using one or more grain flours that were the same as the one or more grain flours in the sample slurries, with the exception that the one or more grain flours were not cooked and dried according to the aspects of the present disclosure. The liquid for the comparable slurries was the same as the liquid used to prepare sample slurries. Data supporting these observations is found in FIGS. 1 and 2 and Tables 1 and 2.

In some embodiments, the final viscosity of the sample slurries was less than the final viscosity of the comparable slurries, as measured using RVA with an initial temperature of about 50° C. (122° F.) and a maximum temperature of about 95° C. (203° F.). The comparable slurries were prepared as described above. Data supporting these observations is found in FIGS. 1 and 2 and Tables 1 and 2.

### Example 8

The viscosity profile of exemplary binder compositions of the present disclosure were characterized with a Brookfield Digital Viscometer using an SC4-27 spindle (Brookfield Engineering Laboratories, Inc.). The data was obtained for exemplary binder compositions comprising whole oat flour in combination with either water, juice, or 2% milk. The whole oat flour binder compositions were prepared using each liquid in combination with uncooked grain flour (control), extrusion cooked grain flour, or jet cooked grain flour. The viscosity at different shear rates was measured at ambient temperature for each of the binder compositions. The binder compositions prepared from the jet cooked grain flour had the greatest viscosity. The binder compositions prepared from the extrusion cooked grain flour had an intermediate viscosity. The binder compositions prepared from uncooked grain flour had the lowest viscosity. (See Table 3).

TABLE 3
Uncooked Grain Flour

| Water | | Juice | | 2% Milk | |
|---|---|---|---|---|---|
| Shear | | Shear | | Shear | |
| rate | Viscosity | rate | Viscosity | rate | Viscosity |
| (1/s) | (poise) | (1/s) | (poise) | (1/s) | (poise) |
| 1.0 | 5.66 | 1.0 | 6.37 | 1.00 | 4.94 |
| 1.6 | 5.24 | 1.6 | 5.85 | 1.6 | 4.39 |
| 2.5 | 4.86 | 2.5 | 5.14 | 2.5 | 3.94 |
| 4.0 | 4.44 | 4.0 | 4.48 | 4.0 | 3.56 |
| 6.3 | 3.96 | 6.3 | 3.76 | 6.3 | 3.08 |
| 10.0 | 3.39 | 10.0 | 3.02 | 10.0 | 2.62 |

Extrusion Cooked Grain Flour

| Water | | Juice | | 2% Milk | |
|---|---|---|---|---|---|
| Shear | | Shear | | Shear | |
| rate | Viscosity | rate | Viscosity | rate | Viscosity |
| (1/s) | (poise) | (1/s) | (poise) | (1/s) | (poise) |
| 1.0 | 741.2 | 1.0 | 1503.0 | 1.0 | 748.0 |
| 1.6 | 538.0 | 1.6 | 1024.0 | 1.6 | 516.5 |
| 2.5 | 414.5 | 2.5 | 704.4 | 2.5 | 371.2 |
| 4.0 | 311.0 | 4.0 | 490.4 | 4.0 | 269.9 |
| 6.3 | 236.0 | 6.3 | 354.5 | 6.3 | 202.6 |
| 10.0 | 175.4 | 10.0 | 257.7 | 10.0 | 154.4 |

Jet Cooked Grain Flour

| Water | | Juice | | 2% Milk | |
|---|---|---|---|---|---|
| Shear | | Shear | | Shear | |
| rate | Viscosity | rate | Viscosity | rate | Viscosity |
| (1/s) | (poise) | (1/s) | (poise) | (1/s) | (poise) |
| 1.0 | 1401.0 | 1.0 | 1836 | 1.00 | 1884.0 |
| 1.6 | 1102.0 | 1.6 | 1463 | 1.6 | 1390.0 |
| 2.5 | 875.1 | 2.5 | 1130 | 2.5 | 975.3 |
| 4.0 | 669.7 | 4.0 | 863 | 4.0 | 719.3 |
| 6.3 | 475.2 | 6.3 | 646 | 6.3 | 516.2 |
| 10.0 | 362.4 | 10.0 | 485 | 10.0 | 365.8 |

### Example 9

The viscosity profile of binder compositions of the present disclosure were further characterized with an AR2000ex Rheometer using a Starch Pasting Cell (TA Instruments). The data was obtained for exemplary binder compositions comprising whole oat flour in combination with either water, juice, or 2% milk. The whole oat flour binder compositions were prepared using each liquid in combination with uncooked grain flour (control), extrusion cooked grain flour, or jet cooked grain flour. The viscosity at different shear rates was measured at ambient temperature for each of the binder compositions. The binder compositions prepared from the jet cooked grain flour had the greatest viscosity. The binder compositions prepared from the extrusion cooked grain flour had an intermediate viscosity. The binder compositions prepared from the uncooked grain flour had the lowest viscosity. (See Table 4).

TABLE 4
Uncooked Grain Flour

| Water | | Juice | | 2% Milk | |
|---|---|---|---|---|---|
| Shear | | Shear | | Shear | |
| rate | Viscosity | rate | Viscosity | rate | Viscosity |
| (1/s) | (poise) | (1/s) | (poise) | (1/s) | (poise) |
| 1.0 | 2.04 | 1.0 | 1.03 | 1.0 | 1.12 |
| 1.6 | 1.96 | 1.6 | 0.97 | 1.6 | 1.08 |
| 2.5 | 1.87 | 2.5 | 0.93 | 2.5 | 1.07 |
| 4.0 | 1.77 | 4.0 | 0.90 | 4.0 | 1.06 |
| 6.3 | 1.65 | 6.3 | 0.90 | 6.3 | 1.05 |
| 10.0 | 1.42 | 10.0 | 0.95 | 10.0 | 1.11 |

Extrusion Cooked Grain Flour

| Water | | Juice | | 2% Milk | |
|---|---|---|---|---|---|
| Shear | | Shear | | Shear | |
| rate | Viscosity | rate | Viscosity | rate | Viscosity |
| (1/s) | (poise) | (1/s) | (poise) | (1/s) | (poise) |
| 1.0 | 299.4 | 1.0 | 542.1 | 1.0 | 312.5 |
| 1.6 | 209.7 | 1.6 | 383.3 | 1.6 | 223.7 |
| 2.5 | 154.9 | 2.5 | 282.5 | 2.5 | 165.0 |
| 4.0 | 116.8 | 4.0 | 211.7 | 4.0 | 125.4 |
| 6.3 | 88.4 | 6.3 | 158.9 | 6.3 | 98.5 |
| 10.0 | 66.5 | 10.0 | 120.0 | 10.0 | 80.3 |

Jet Cooked Grain Flour

| Water | | Juice | | 2% Milk | |
|---|---|---|---|---|---|
| Shear | | Shear | | Shear | |
| rate | Viscosity | rate | Viscosity | rate | Viscosity |
| (1/s) | (poise) | (1/s) | (poise) | (1/s) | (poise) |
| 1.0 | 702.2 | 1.0 | 857.6 | 1.0 | 759.8 |
| 1.6 | 507.6 | 1.6 | 640.1 | 1.6 | 535.6 |
| 2.5 | 369.1 | 2.5 | 489.5 | 2.5 | 385.3 |
| 4.0 | 273.3 | 4.0 | 374.8 | 4.0 | 280.9 |
| 6.3 | 203.5 | 6.3 | 282.7 | 6.3 | 196.2 |
| 10.0 | 150.5 | 10.0 | 213.2 | 10.0 | 126.3 |

### Example 10

This example illustrates exemplary binder and slurry compositions made according to the present disclosure. The compositions are set forth in Tables 5 and 6 below.

TABLE 5
Exemplary Binder composition
for Savory Food Products

| Ingredient | % |
|---|---|
| Water | 81 |
| Cooked Grain | 11 |
| Fat or oil | 5.7 |
| Salt | 1.1 |

TABLE 6
Exemplary Slurry Formulas
for Binder Compositions

| Ingredient | % | % |
|---|---|---|
| Cooked | 56.3 | 92.3 |
| Waxy Rice | | |
| (30% grains) | | |
| Canola oil | 4.2 | 6.0 |
| Sugar | 21.7 | — |
| Salt | 2.2 | 1.6 |
| Flavor paste | 12.6 | — |
| Seasonings | 3.0 | 0.1 |

The above binder compositions may be added to dry ingredients at a ratio of slurry to dry of about 25:75 to about 45:55.

### Example 11

In accordance with some embodiments, a binder composition of the present disclosure may include the following ingredients:

| | Broadest range | Narrower range |
|---|---|---|
| | of percent | of percent |
| | by weight | by weight |
| | based on | based on |
| Component | total weight | total weight |
| Cooked grain slurry | 70-100 | 80-90 |
| (15-40% grain) | | |
| Sugar/Syrup | 0-10 | 2-5 |
| Fat or Oil | 1-10 | 2-8 |
| Salt | 0-2 | 0-1 |
| Flavorings | 0-1 | 0-0.5 |

The whole grain flour (with 15-40% in water) can be hydro-thermo cooked at about 290° C. for about 4-6 minutes to form a glue like cooked grain material (slurry or paste depends on the grain type or concentration). The cooked grain material can be optionally mixed with sugar/syrup, fat or oil, salt, and/or flavorings to give the binder composition. The cooked grain material can also be used alone as the binding composition. Nut butter/paste or fruit paste can also be included to the binding composition also.

The above description is merely exemplary in nature and is not intended to limit the present disclosure, application, or uses. The aspects and embodiments of the present disclosure described above are not intended to be exhaustive or to limit the disclosure to the precise forms disclosed in the following detailed description. Rather, the embodiments are chosen and described so that others skilled in the art may appreciate and understand the principles and practices of the present disclosure. The above definitions and non-limiting guidelines must be considered in reviewing the description of the technology set forth herein.

The headings (such as “Technical Field,” “Background,” and “Summary of the Disclosure”) and sub-headings used herein are intended only for general organization of topics within the present technology, and are not intended to limit the scope of the disclosure of the present technology or any aspect thereof. In particular, subject matter disclosed in the “Background” may include novel technology and may not constitute a recitation of prior art. Subject matter disclosed in the “Summary of the Disclosure” is not an exhaustive or complete disclosure of the entire scope of the technology and is not intended to be used to limit the range of the subject matter that is disclosed herein. Any recitation in the “Abstract” of this application is not intended to be used to construe the scope of the claims or to limit the scope of the subject matter that is disclosed herein. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. Any discussion of the content of references cited in the “Background” is intended merely to provide a general summary of assertions made by the authors of the references, and does not constitute an admission as to the accuracy of the content of such references. Any references cited in the “Detailed Description” section of this specification are hereby incorporated by reference in their entirety.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the compositions and methods of this technology and, unless explicitly stated otherwise, are not intended to be a representation that given embodiments of this technology have, or have not, been made, or tested. Any use of the past tense to describe an example that may otherwise be indicated as constructive or prophetic is not intended to reflect that the constructive or prophetic example has actually been carried out.

As referred to herein, all compositional percentages and ratios are by weight of the total composition, unless otherwise specified. As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

Applicants reserve the right to proviso out any selection, group, element, or aspect, for example, to limit the scope of any claim to account for a prior disclosure of which Applicants may be unaware.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A method for preparing a food product including a grain-based binder and being essentially free of added sugars, the method comprising:
preparing a cooked grain flour;
hydrating the cooked grain flour with a liquid to form a binder composition;
mixing the binder composition and one or more dry ingredients to form an agglomerate; and
thermally processing the agglomerate to obtain the food product.

2. The method of claim 1, wherein the cooked grain flour is prepared by cooking one or more grain flours and wherein the one or more grain flours are selected from the group consisting of barley, oat, wheat, corn, millet, buckwheat, quinoa, rice, sorghum, triticale flour, mixtures thereof, and their waxy varieties.

3. The method of claim 2, wherein the cooked grain flour is prepared by cooking and drying the one or more grain flours.

4. The method of claim 3, wherein the cooking is at a temperature of about 250° F. to about 350° F. for about 2 minutes to about 8 minutes.

5. The method of claim 1, wherein the cooked grain flour is prepared by steam jet cooking one or more grain flours.

6. The method of claim 1, wherein the cooked grain flour is prepared by steam jet cooking and drum drying one or more grain flours.

7. The method of claim 1, wherein the cooked grain flour has a moisture content of about 2% to about 10% by weight based on a total weight of the cooked grain flour.

8. The method of claim 1, wherein a ratio of the cooked grain flour to the liquid in the binder composition is about 1:1 to about 1:20 by weight.

9. The method of claim 1, wherein the binder composition comprises about 5% to about 30% by weight of the cooked grain flour based on a total weight of the binder composition.

10. The method of claim 1, wherein the binder composition comprises about 5% to about 30% by weight of the cooked grain flour based on a total weight of the binder composition, about 2% to about 8% by weight oil based on a total weight of the binder composition; and about 0.5% to about 1% by weight salt based on a total weight of the binder composition.

11. A method for preparing a food product including a grain-based binder and being essentially free of added sugars, the method comprising:
cooking raw grains with a liquid to form a binder composition;
mixing the binder composition and one or more dry ingredients to form an agglomerate; and
thermally processing the agglomerate to obtain the food product.

12. The method of claim 11, wherein the raw grains include one or more grains selected from the group consisting of barley, oat, wheat, corn, millet, buckwheat, quinoa, rice, sorghum, triticale flour, mixtures thereof, and their waxy varieties.

13. The method of claim 11, wherein the cooking is at a temperature of about 250° F. to about 350° F. for about 2 minutes to about 8 minutes.

14. The method of claim 11, wherein the cooking is by steam jet cooking one or more raw grains.

15. The method of claim 11, wherein a ratio of the cooked raw grains to the liquid in the binder composition is about 1:1 to about 1:20 by weight.

16. The method of claim 11, wherein the binder composition comprises about 5% to about 30% by weight of the cooked raw grains based on a total weight of the binder composition.

17. The method of claim 11, wherein the binder composition comprises about 5% to about 30% by weight of the cooked raw grains based on a total weight of the binder composition, about 2% to about 8% by weight oil based on a total weight of the binder composition; and about 0.5% to about 1% by weight salt based on a total weight of the binder composition.

18. A reduced sugar food product with a grain-based binder, the reduced sugar food product comprising:
a grain-based binder composition including one or more cooked grain flours and a liquid;
one or more dry ingredients; and
wherein the binder composition is essentially free of an added sugar.

19. The product of claim 18, wherein the cooked grain flour is prepared by cooking and drying one or more grain flours.

20. The product of claim 18, wherein the one or more cooked grain flours are selected from the group consisting of barley, oat, wheat, corn, millet, buckwheat, quinoa, rice, sorghum, triticale flour, mixtures thereof, and their waxy varieties.

21. The product of claim 18, wherein the cooked grain flour is prepared by steam jet cooking and drum drying one or more grain flours.

22. The product of claim 18, wherein the cooked grain flour has a moisture content of about 2% to about 10% by weight based on a total weight of the cooked grain flour.

23. The product of claim 18, wherein a ratio of the cooked grain flour to the liquid in the binder composition is about 1:1 to about 1:20 by weight.

24. The product of claim 18, wherein the food product comprises about 10% to about 50% by weight of the binder composition and about 50% to about 90% by weight of the one or more dry ingredients based on a total weight of the food product.

25. The product of claim 18, wherein the food product has a moisture content of about 1% to about 10% by weight based on a total weight of the food product.

26. The product of claim 18, wherein the food product is essentially free of an added sugar.
